(19) United States
(12) Patent Application Publication
(10) Pub. No.: US 2026/0301104 A1
(43) Pub. Date: Oct. 1, 2026

(54) Planning and Execution of Preparedness Exercises

(71) Applicant: Disaster Technologies Incorporated, Alexandria, VA (US)

(72) Inventors: Vincent DePersio, Knoxville, TN (US); Sean Griffin, Alexandria, VA (US); Nikko Mitrano Schaff, Montour Falls, NY (US); Roger Coleman, Plandome, NY (US)

(21) Appl. No.: 19/475,675

(22) PCT Filed: Apr. 16, 2024
(86) PCT No.: PCT/US2024/024760

§ 371 Date: Oct. 15, 2025

Related U.S. Application Data
(60) Provisional application No. 63/496,519, filed on Apr. 17, 2023.

(51) Int. Cl. G06Q 90/00

(52) U.S. Cl. CPC G06Q 90/205

(57) ABSTRACT

An exercise planning and management system provides a collaborative workspace environment for designing, managing, and evaluating exercises, for example, incident management teams in commercial industries to prepare individuals or test capabilities for real-world events. This system combines customizable features to support various exercise scenarios on a single platform that is scalable to support unlimited users in a complex and centralized information environment across various continents and time zones. The system can operate on a secure, cloud-based environment accessed by any device (computer, tablet, or smartphone) with an internet connection and centralizes and integrates an entire process into a single collaborative platform. These complex processes are transformed into a more intuitive user-friendly interface with customizable inputs, navigational components, and features. The value of the exercises is enhanced by ensuring that users plan, complete, and assess prioritized objectives through an accountable process to provide real-time performance data analytics.

### RELATED APPLICATION DATA

This application claims the benefit of priority of U.S. Provisional Patent Application Ser. No. 63/496,519, filed Apr. 17, 2023, and titled “Planning and Execution of Preparedness Exercises”, which is incorporated by reference herein in its entirety.

### FIELD OF THE DISCLOSURE

The present invention generally relates to the field of incident management and in particular to a system and method for providing planning and execution of preparedness exercises.

### BACKGROUND

In many organizations, the purpose of preparedness exercises, particularly joint exercises involving more than one organization is to prepare organizations and individuals, validate plans, practice processes and procedures, and test new or existing capabilities, using realistic scenarios.

These exercises provide the opportunity to recognize, share, integrate, and reduce capability gaps, develop new techniques, and identify lessons learned. An organization's objectives that are accomplished and assessed in an exercise are not necessarily an evaluation of the organization, rather a set of performance-based tasks the organization expects to achieve for contribution towards their overall preparedness.

Determining the effectiveness and value of exercises for preparedness has long been a challenge but is of high interest to decision makers in public, private, and government sectors. Thus, there is a need for improved systems and methods for providing designing and conducting preparedness exercises.

### SUMMARY OF THE DISCLOSURE

A method of conducting an exercise for assessing preparedness for responding to incidents includes generating, in a system having a plurality of modules and applications, a replicated internet environment with a plurality of replicated sites, defining a plurality of characters for engaging with at least one of the plurality of replicated sites, wherein each of the plurality of characters includes a profile associated at least one of the plurality of replicated sites, defining one or more networks, each having a category, assigning the profile for each of the plurality of characters to one of the categories, generating a plurality of noise profiles, wherein the noise profiles are not associated with any of the categories or any of the one or more networks, receiving information from a plurality of external information sources, removing any identifying information from the received information, filtering the received information based on a selected area of interest or a selected topic, generating a plurality of noise posts based on the filtered received information and associating each of the plurality of noise posts with one of the plurality of noise profiles, receiving a character post input by one or more character-assigned users for at least one of the plurality of characters, posting the character post to one of the plurality of replicated sites based on the profile for the at least one of the plurality of characters, posting a selected number of the plurality of noise posts to ones of the plurality of replicated sites, and running the replicated internet environment such that the selected number of the plurality of noise posts and the character post are accessible to users accessing the replicated internet environment.

Additionally or alternatively, the posting the selected number of the plurality of noise posts is on an hourly basis.

Additionally or alternatively, the defining the plurality of characters is performed by one or more administrative users.

Additionally or alternatively. a subset of the plurality of characters are assigned to one of the one or more networks.

Additionally or alternatively. a plurality of objectives is added.

Additionally or alternatively. the plurality of objectives is assessed based on outcomes derived from the running the replicated environment.

Additionally or alternatively, the method further includes receiving a plurality of documents and adding scenarios to the environment based on content of the plurality of documents.

Additionally or alternatively, the method further includes aligning the plurality of objectives with a plurality of priorities entered by one or more administrative users.

Additionally or alternatively, the method further includes permitting communication between the one or more administrative users and the character-assigned users.

Additionally or alternatively, the method further includes assigning one or more response roles to response users, wherein the response users are not connected to the character-assigned users during the exercises.

Additionally or alternatively, the method further includes displaying an interactive 3D map of an area in which the exercise is set.

A system for conducting planning and management exercise in a replicated internet environment includes an organization application configured to prepare a workspace for an exercise and to associate members with the exercise workspace, a plan application including a design module configured to receive the exercise workspace and the associated members from the organization application and to associate a plurality of objective with the exercise, and wherein the plan application includes a conduct exercise module configured to conduct the exercise based on a plurality of scenario event list injects, a notebook application configured to create a plurality of folders associated with the exercise workspace and to receive a plurality of documents in each of the plurality of folders, and a media application configured to generate replicated news and social media cites for the replicated internet environment and a plurality of profiles associated with respective personas, wherein a plurality of posts are created and associated with respective ones of the plurality of profiles, and wherein the plurality of posts are presented on the replicated news and social media cites.

Additionally or alternatively, the plurality of posts are created based in part on external publicly available sources.

### BRIEF DESCRIPTION OF THE DRAWINGS

For the purpose of illustrating the disclosed embodiments, the drawings show aspects thereof. It is to be understood, however, that the teachings of the present disclosure are not limited to the precise arrangements and instrumentalities shown in the drawings, wherein:

FIG. 1 is a process diagram outlining a process for generating a replicated internet playground in accordance with an embodiment of the present invention; and

FIG. 2 is a process diagram outlining the exercise planning and management process according to an embodiment of the present invention.

### DETAILED DESCRIPTION

The present invention offers a flexible, scalable, and customizable exercise planning and management system that captures requirements, aligns objectives to plans, priorities, and scenario injects, correlates data, and provides real-time analysis of results. Current exercise planning and management methods are antiquated and inefficient at providing the proper tools to maximize the value of training and the analytics for validation.

The exercise planning and management system of the present invention provides a collaborative workspace environment for designing, managing, and evaluating exercises, for example, incident management teams in commercial industries to prepare individuals or test capabilities for real-world events. This system combines customizable features to support various exercise scenarios on a single platform that is scalable to support unlimited users in a complex and centralized information environment across various continents and time zones. The system can operate on a secure, cloud-based environment accessed by any device (computer, tablet, or smartphone) with an internet connection.

The exercise planning and management system improves the process by centralizing and integrating an entire process into a single collaborative platform. These complex processes are transformed into a more intuitive user-friendly interface with customizable inputs, navigational components, and features. The value of the exercises is enhanced by ensuring that users plan, complete, and assess prioritized objectives through an accountable process to provide real-time performance data analytics. In addition, a dynamic lexicon makes the system more easily adaptable to different communities and industries. A map feature includes integrated layers of the planning and management process that visually support situational awareness of past, present, and future data. The collaborative, centralized capability reduces labor hours by eliminating the need for multiple documents and artifacts with the same or similar information/data. The exercise planning and execution system reduces planning cycles with organizational data libraries or workspace creation and provides an “Exercise in a box” with templated workspaces using specific scenarios, Master Scenario Events List (MSELs), and Objectives. Users can analyze data in real-time to adjust exercise play and maximize the value of execution by focusing on high priority objectives. Real-time analytics significantly reduces time for authoring daily or after-action reports, which can improve return-on-investment (ROI). Further, any scale of exercises is supported from Tabletop to full-scale or field exercises. Logistical and communication resource requirements can be captured, allocated, and managed for exercise support (exercise control) and exercise play (participants). Resource costs can be tied to exercise objectives to provide a more realistic determination of exercise efficiency and ROI.

Through these features, the system can provide analytics and feedback regarding completed exercises for organizations such as the following: Which performance-based objectives were accomplished compared to the objectives that were planned? What was the effectiveness of the identified performance measures, and the cost value of conducting the exercise? How do the completed performance-based objectives align with strategic priorities (e.g., Joint Staff, Combatant Command(s), State Plans, County Plans, etc.)? What is the cost to complete each objective per various aspects? Which objectives were or were not completed per applicable standards at the various strategic priority levels? Other metrics that outline what was required to complete the objectives? Were the objectives accomplished effectively, and to the extent not, what were the reasons for ineffectiveness? What did each enabling or supporting participant contribute towards the primary audience objectives? What was the cost of the enabler force that directly supported the primary audience performance-based objectives as a whole? Per organizational levels? What trends were identified as a combination of all exercises?

The system may include a suite of intelligent and interconnected applications. Users may fully plan, conduct, and assess any exercise scenario through an interface for accomplishing exercise planning. Centralizing all exercise data within a single system streamlines planning, ensures accountability, reduces duplication of processes and information, and improves the management of the exercise flow. Dashboards are used to provide users situational awareness throughout the exercise planning and execution process. In a preferred embodiment, the using organization's exercise data is not accessible to the general public. A robust knowledge base helps users with tasks such as creating objectives to ensure they meet certain criteria.

The system is scalable and flexible so that many different scopes of exercise may be conducted, from tabletop to full-scale or field exercises, and type of exercise, such as for training personnel or testing equipment and capabilities. Simulating realistic conditions participants would encounter (e.g., engaging in operational conflicts or responding to incidents and disasters) is provided for through scripted scenarios and injects, which provide several opportunities for participants (players) to successfully meet objectives.

Following the exercise planning and execution process, users can define the exercise parameters and life cycle dates (e.g., planning conferences), establish funding budgets, and align exercise priorities to user-defined strategic objectives. Participant planners (or trusted agents) input organizational information, document objectives, and align objectives to exercise priorities. These details help exercise planners and scripters determine and design one or more exercise event scenarios, capture support requirements, and create MSEL injects for each event and link to participant objectives to ensure proper focus and accountability. MSEL injects that require file attachments such as documents, images, videos, etc. can link to files uploaded and stored in the information management application. Simulated internet media sources are linked from a replicated internet playground application. Users can make scenario injects be dependent on other injects as required for more dynamic exercise play. A dashboard element provides users the ability to view and edit exercise details, and view and download snapshots of MSEL injects and relevant analytical charts essential to the planning phase of the exercise.

Organization users in the Exercise Control Group (ECG), as designated in the system, manage execution flow primarily using an interactive MSEL timeline tool, and other applications that perform information management, internet media simulation, situational awareness through visualization, and communication functions. Replicated aggressors have access to required information and schedules using the platform to ensure smooth and efficient exercise play. The interactive MSEL timeline tool notifies users of overdue scheduled injects, and helps ensure dependent injects are completed accordingly. The timeline is displayed chronologically, and the list can be filtered by start and end dates, and/or by an event. A dashboard for the conduct phase provides users the ability to view analytical charts essential for situational awareness to manage the exercise execution phase. Users can filter views and download snapshots of the graphs. Selecting MSEL injects on a calendar displays an interactive modal for users to view or edit inject details to include aligned objectives, edit player response time and actions, and update inject status. An activity log displays who, what, and when changes were made to the inject.

Evaluation and feedback forms may be pre-populated to document measurements of participant objective standards, final grading, level of effectiveness, reasons for ineffectiveness, additional metrics towards completing the objective, and any descriptive commentary. Both forms also offer users the opportunity to document any lessons learned from an exercise. Evaluation forms may be used by controllers/evaluators, and feedback forms may be used by participants for self-assessment. Submitted forms of these types may serve as the primary sources of real-time analytical data visualized in graphical representations. Users can also record and post observations of the objectives or the exercise environment to capture and detail important events, weather, or other unexpected issues, etc., throughout the course of the exercise.

As each evaluation and/or feedback form is submitted, the data and information populate real-time graphical analytics for ECG members and leadership to view and make informed decisions. This can improve and even maximize exercise value by allowing users to adjust their exercise in real-time with focus on high priority objectives within the allotted time remaining in the exercise. This data is evaluated in a qualitative and quantitative manner, allowing for users to see the strengths and weaknesses of the performance-based objectives and the exercise environment itself, ensure resources are used efficiently, and opportunities are maximized. The analytics is used to create customized reports filtered by various options (e.g., start and end dates/times of completed injects, assessment or feedback data) for daily briefings and after-action review. Real-time data significantly reduces the amount of time previously required to generate such reports. The archival of data from all of an organization's exercises over time is used to conduct trend analysis. The trend analysis allows the organization to further maximize the value of their exercises by identifying gaps and determining long term effectiveness.

The replicated Internet playground application allows users (scripters) to create a realistic publicly available information environment that includes social and news media, video blogs, forums, and more, which may be suitable for any use. Replicated sites are created that are desired for use in the exercise environment. Next, users define the main characters of the exercise scenarios by creating personas and adding details such as a profile image, their role in the storyline, customizable attributes (e.g., aliases, gender, birthdate/age, hair and eye color, etc.), create linking relationships to other personas, and descriptive commentary regarding the character, and establishing profiles on the sites users intend to publish their posts with. Networks can be created and used to assign profiles into customized categories such as news organizations, combatant cells, etc. Additional profiles can be created without specific associations to establish personas for scripted content to help drive scenarios.

Once the personas and profiles are established, scripters then create customized posts that can be scheduled or instantly published on replicated sites in the internet playground environment. This scripted content is tailored for injects to drive participant objectives or ensure exercise flow. More realistic conditions are created by injecting publicly available information (PAI) obtained from a variety of sources. This feature may be referred to as “noise” and is scrubbed for any personally identifiable information. This modified noise content is then republished on the replicated sites in the containerized internet playground environment with artificial names and images. Source noise can be filtered using keywords. The amount of noise posts may be controlled by selecting the rate per hour to integrate with scripted posts. Intelligence analysts can be challenged against key tasks through the replicated PAI environment while controlling the pace and focus of the posts.

An information management application is used for centralized storage and sharing of files such as documents, images, and videos pertinent to an exercise which can reduce or eliminate issues such as stove-piped planning or version control issues. Users can also create notes, plans, tasks, or orders. The document creation tool allows for more effective collaboration and the addition of icons and colors for simple identification. These documents can be customized with sections and pages for easy navigation. Folders and sub-folders can be created and customized with icons and colors to organize file storage. Access can be restricted to select files and folders through permissions-based functionality.

An interactive 3D map may be used to provide a visual display of the exercise environment to the ECG to maximize situational awareness. Customized shapes may be created and data from internal applications and external sources integrated with selectable layers to filter and display a customized viewpoint of the geographical setting. Data available on the interactive map is linked to sources such as scenario events with MSEL injects, participant objectives, logistics and resources, media posts, and weather. Aside from real-time data updates by displaying live source feeds, users can view the planned and post exercise play using a timescale playback function for quick decision making to improve exercise value.

ECG members can communicate using email and chat during the planning and execution phases of the exercise. Keeping all communications pertinent to the exercise in a central location ensures continuity of operations, accountability of information, and eliminates the dependency or need for cross-compatibility with multiple services.

A learning management system application allows users to manage individual training and assessment. Users may have access to a central location for educational purposes via any device.

An organization application allows organizational users to create, view, and manage their exercise workspaces, allocate, manage, and deconflict personnel and resources to support exercises, deconflict event dates, and view reports for status and trend analysis. All post exercise data stored helps organizations determine overall effectiveness, cost, and ROI. Exercise workspaces can be duplicated from previous exercises, or created using data libraries of participants, objectives, MSEL injects, and media from replicated internet playground application which significantly reduces the workload and time required for preparation and planning of exercises.

In an embodiment, a developer application allows users to create workspaces and invite/manage users to the platform and assign such users to the platform. Access to this application may be limited.

A logistics application captures, sources, allocates, and manages logistical and communication requirements for an exercise. The process begins with participants documenting the types and quantity of logistic and communication requirements, location(s), and dates/times required. These requirements and those for the overall exercise identified by a (logistics) planner are consolidated for validation and sourcing. Once sourced, allocation will be documented and managed accordingly throughout the exercise life cycle. Sourced costs are captured and aligned to participants and objectives which improves the detailed analysis of exercise costs by select categories. Users will be able to track what logistics and resources they have access to as well as when and where they'll need to use the resources to conduct an effective exercise. Logistics and communication resource locations will be integrated with the map application for situational awareness and integrated management by planners. Logistical requirements and resources can be notional for tabletop and other exercises that do not require physical resources to provide a realistic effect.

An Exercise Settings application allows users the flexibility to access and manage field values in each workspaces' drop-down boxes for a tailored experience. The drop-down values may be customized throughout the system's interfaces. Users may also select a time zone for the workspace, which is preferably set to where the ECG would be located. All users can manage their personal profile settings.

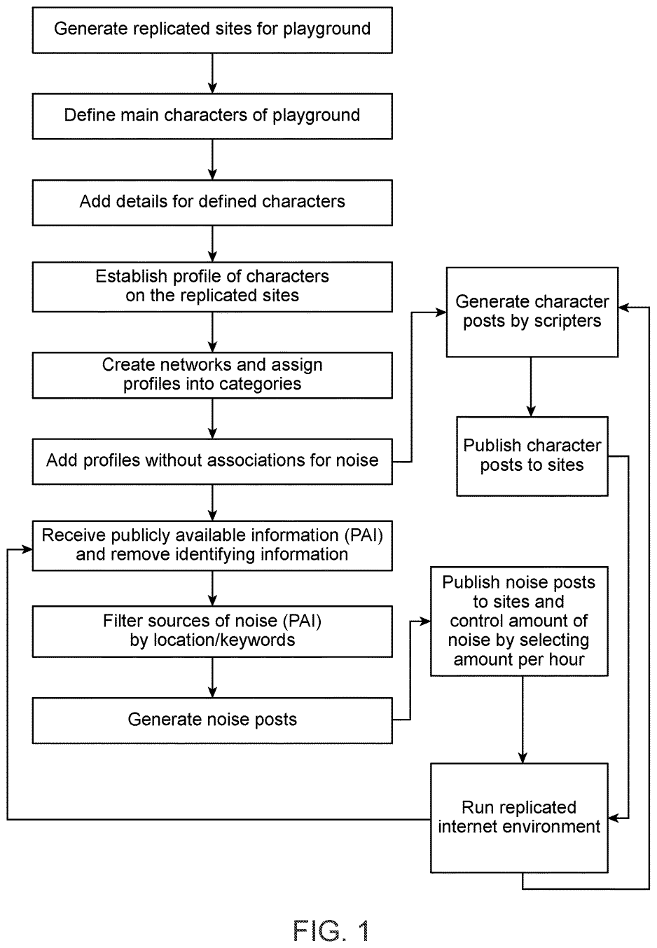

Turning to FIG. 1, a process is outlined for a preparedness exercise. A replicated internet environment playground is created and replicated sites (e.g., social media, websites created within the containerized workspace environment) are generated for the specific playground. The media app is used to create the replicated internet environment playground and users can add details to enhance and modify the playground. In addition, a plurality of main characters are defined for the exercise for the playground, and details are added for these defined characters. Profiles are established for these characters on the replicated sites. These main characters are part of the storyboard of the exercise. Personas are created for them to replicate aggressors, news anchors, contributors of content, etc .. Each main character will have one or more “profiles” that are used to post on the news and social media sites that have been created in the replicated environment. Further, other profiles may be established without being associated with any of the main characters to generate “noise” in the playground environment based on these other profiles.

At this point, content for the exercise is generated in two ways. For the defined characters, scripters, i.e., content creators for the characters, generate posts for those characters based on the character's profile and details. These posts are then published to the replicated sites under the associated character's profile. For the unassociated profiles, publicly available information is received from real sources and any identifying information is removed. This information is then filtered based on a selected location (e.g., area of interest) and/or keywords to select to various subject matter. The filtered results are then used to generate noise posts, which are published to the replicated sites at a selected number per hour.

With the character and noise posts posted to the replicated sites, the replicated internet environment executes as scheduled posts. Based on information available in the replicated internet environment, scripters generate more posts for the characters and publish them again while the system receives a new batch of publicly available information, removes identifying information, filters based on selected criteria, and generates more noise posts that are published at the selected rate.

In this way, users having response roles will be presented with various, ongoing scenarios and will determine appropriate actions based on information accessible within the playground. The users with response roles will not have access that allows determining whether a given post or other information is from a noise post or a character post.

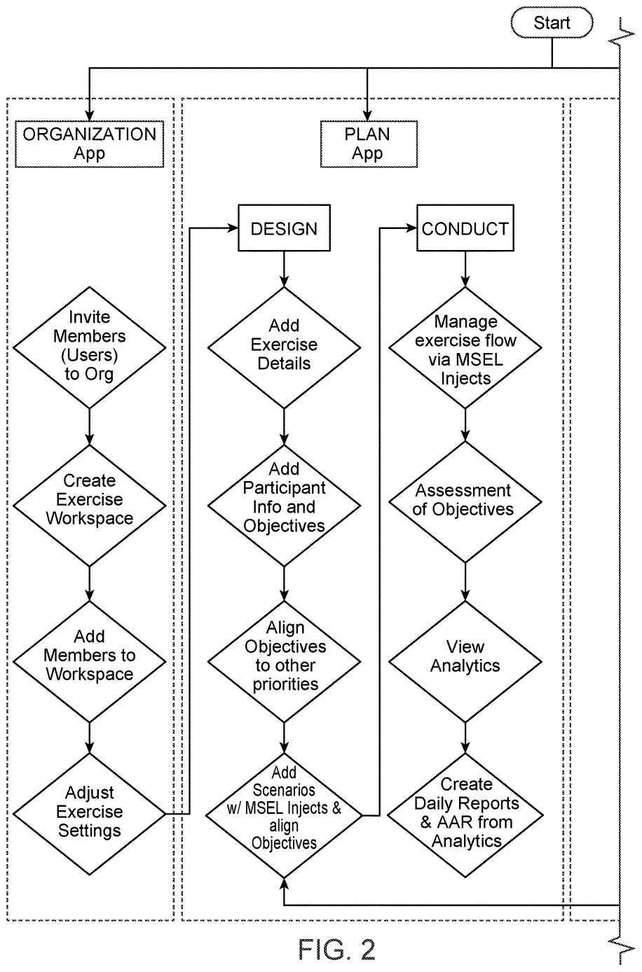

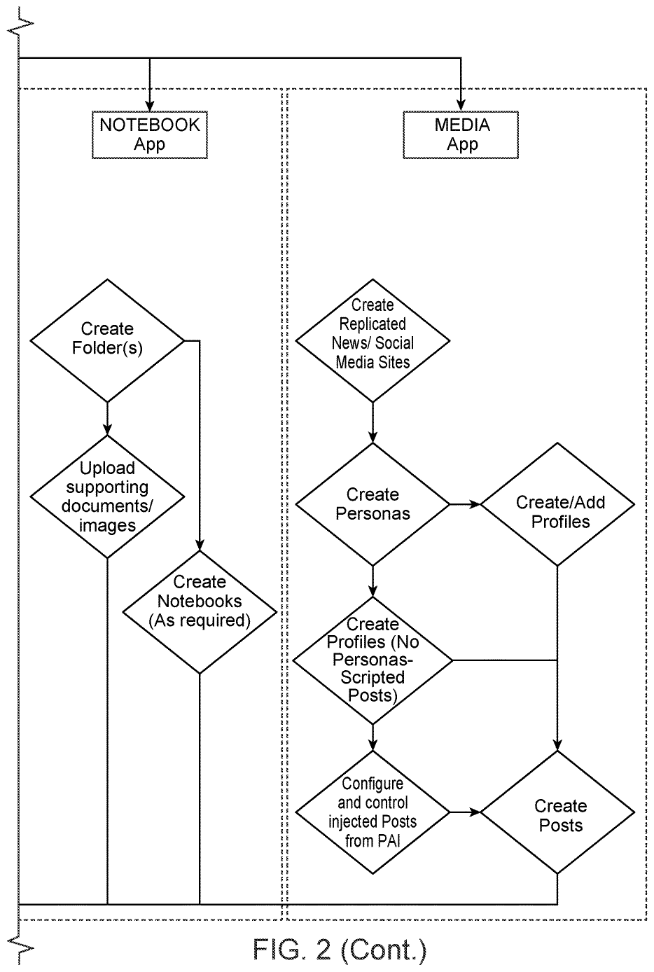

Turning to FIG. 2, a process diagram is provided that outlines an exemplary exercise planning and management process as described herein. From a start option, an organization application, a plan application, a notebook application, and a media application can be accessed, all of which are accessed to set up and conduct an exercise and may be interrelated.

The organization application includes an option to invite members (or users) to an organization that is recognized and stored in the system. An exercise workspace is created and members can be added to that exercise workspace.

In the plan application, a design module receives the created exercise workspace and the members that are included in that workspace from the organization application. The design module can then add exercise details, as well as information about participants and objectives for the given exercise. The objectives can then be aligned to other priorities of the organization by listing and selecting each of the other priorities at the end of the participant objective stepper. Scenarios with MSEL injects are added and objectives are again aligned. At this point, a conduct exercise module is accessed which allows for the management of exercise flow via the MSEL injects. An assessment of objectives is made and then the analytics may be made available to selected users for viewing. Daily reports and After Action Reports (AAR) are obtained from these analytics.

A notebook application involves information management for planning and execution. The notebook application includes an option to create folders, and notebooks as needed. Files such as supporting documents and images can be uploaded to the folders

A media application can be used to support MSEL injects or as a standalone containerized training environment for intelligence and information operations. In the media application, replicated news and/or social media sites are created as well as personas for use in the exercise. Profiles for the personas are created and added to the system. Profiles are also created for scripted posts, which do not include personas. Posts can then be created based on the profiles for both the profiles with and without personas. Posts are configured and controlled that were created from PAI. All of these posts are then used as part of the plan application as ongoing components of the scenarios with MSEL injects, which can then be part of the alignment of objectives.

In this way, a replicated environment can be generated for simulating scenarios to conduct exercises in which objectives can be assessed and aligned with priorities identified by users.

Any one or more of the aspects and embodiments described herein may be implemented using one or more machines (e.g., one or more computing devices that are utilized as a user computing device for an electronic document, one or more server devices, such as a document server, etc.) programmed according to the teachings of the present specification.

Such software may be a computer program product that employs a machine-readable storage medium. A machine-readable storage medium may be any medium that is capable of storing and/or encoding a sequence of instructions for execution by a machine and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

Memory may include various components (e.g., machine-readable media) including, but not limited to, a random access memory component, a read only component, and any combinations thereof. In one example, a basic input/output system (BIOS), including basic routines that help to transfer information between elements within computer system, such as during start-up, may be stored in memory. Memory may also include (e.g., stored on one or more machine-readable media) instructions (e.g., software) embodying any one or more of the aspects and/or methodologies of the present disclosure. In another example, memory may further include any number of program modules including, but not limited to, an operating system, one or more application programs, other program modules, program data, and any combinations thereof.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure.

Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A method of conducting an exercise for assessing preparedness for responding to incidents, comprising:
generating, in a system having a plurality of modules and applications, a replicated internet environment with a plurality of replicated sites;
defining a plurality of characters for engaging with at least one of the plurality of replicated sites, wherein each of the plurality of characters includes a profile associated at least one of the plurality of replicated sites;
defining one or more networks, each having a category;
assigning the profile for each of the plurality of characters to one of the categories;
generating a plurality of noise profiles, wherein the noise profiles are not associated with any of the categories or any of the one or more networks;
receiving information from a plurality of external information sources;
removing any identifying information from the received information;
filtering the received information based on a selected area of interest or a selected topic;
generating a plurality of noise posts based on the filtered received information and associating each of the plurality of noise posts with one of the plurality of noise profiles;
receiving a character post input by one or more character-assigned users for at least one of the plurality of characters;
posting the character post to one of the plurality of replicated sites based on the profile for the at least one of the plurality of characters;
posting a selected number of the plurality of noise posts to ones of the plurality of replicated sites; and
running the replicated internet environment such that the selected number of the plurality of noise posts and the character post are accessible to users accessing the replicated internet environment.

2. The method of claim 1, wherein the posting the selected number of the plurality of noise posts is on an hourly basis.

3. The method of claim 1, wherein the defining the plurality of characters is performed by one or more administrative users.

4. The method of claim 1, wherein a subset of the plurality of characters are assigned to one of the one or more networks.

5. The method of claim 1, further including adding a plurality of objectives.

6. The method of claim 5, further including assessing the plurality of objectives based on outcomes derived from the running the replicated environment.

7. The method of claim 6, further including receiving a plurality of documents and adding scenarios to the environment based on content of the plurality of documents.

8. The method of claim 7, further including aligning the plurality of objectives with a plurality of priorities entered by one or more administrative users.

9. The method of claim 8, further including permitting communication between the one or more administrative users and the character-assigned users.

10. The method of claim 9, further including assigning one or more response roles to response users, wherein the response users are not connected to the character-assigned users during the exercises.

11. The method of claim 10, further including displaying an interactive 3D map of an area in which the exercise is set.

12. A system for conducting planning and management exercise in a replicated internet environment comprising:
an organization application configured to prepare a workspace for an exercise and to associate members with the exercise workspace;
a plan application including a design module configured to receive the exercise workspace and the associated members from the organization application and to associate a plurality of objective with the exercise, and wherein the plan application includes a conduct exercise module configured to conduct the exercise based on a plurality of scenario event list injects;
a notebook application configured to create a plurality of folders associated with the exercise workspace and to receive a plurality of documents in each of the plurality of folders; and
a media application configured to generate replicated news and social media cites for the replicated internet environment and a plurality of profiles associated with respective personas, wherein a plurality of posts are created and associated with respective ones of the plurality of profiles, and wherein the plurality of posts are presented on the replicated news and social media cites.

13. The system of claim 12, wherein the plurality of posts are created based in part on external publicly available sources.
